(19) United States
(12) Patent Application Publication
(10) Pub. No.: US 2011/0208721 A1
(43) Pub. Date: Aug. 25, 2011

(54) METHOD FOR CATEGORIZING PATENTED TECHNOLOGICAL INTERRELATIONSHIPS

(76) Inventor: GAVIN CLARKSON, Houston, TX (US)

(21) Appl. No.: 12/709,941

(22) Filed: Feb. 22, 2010

(51) Int. Cl. G06F 17/30

(52) U.S. Cl. 707/723; 707/769; 707/E17.014

(57) ABSTRACT

A method for identifying patents which are relevant to a field of endeavor by first establishes a set of criteria for defining the field of endeavor and storing the set of criteria in a searchable medium. Using this set of criteria, boundaries are defined within which external data would be considered relevant to the set of criteria. Then a patent database is accessed and compared to the boundaries which have been set in order to identify patents which are relevant to the set of criteria. The patents in the patent database may be subdivided into subsections including at least the following subsections: claims, specification and prior art and optionally including the step of weighting the patents identified as relevant to the set of criteria dependent upon which subsection of each patent is relevant.

### BACKGROUND OF THE INVENTION

1. Field of the Invention

The invention is generally related to search engines and is specifically directed to an automated system for tracking intellectual property, particularly patents and published applications for comparative purposes.

2. Discussion of the Prior Art

As the rate of patenting has increased, so too has the problem of patent thickets, or dense webs of overlapping intellectual property rights that an organization must be aware of in order to assure that it has the right to use specific technology without infringing upon the rights of others. Typically, an organization will undertake a “right-to-use” search by hiring a person or entity with expertise in the desired field to perform a thorough review of the arts. Typically, a substantial portion of the effort involves reviewing the patent arts to determine what rights have been granted to others in the field and to determine the scope of protection. This permits the organization to make an educated guess as to the risk of entering into certain technological fields. Such searches are quite expensive and the results of the search are subjective, at best.

Recently, the United States Patent Office has modified its own search engines, with a result that the accuracy of a prior art search has been greatly improved over the manual or earlier automated systems of the past. The search engines used by the Patent Office are generally available to the public. However, the search engines are not developed for right-to-use research because the search engines are not directed to claim analysis. This is also true of other search engines available over the Internet and other sources. While such advances have been beneficial, the right-to-use analysis still requires manual review of claims in order to assure the freedom to operate.

In order to circumvent the cumbersome task of assuring the freedom to operate in a certain technical sphere, some industries have patent pools, where multiple firms in an industry aggregate their respective patent rights into a package of licenses and cross-licenses. While useful within a targeted industry, the real issue for such firms is the presence of patents and intellectual property rights outside of the historical industry sphere. With approximately 200,000 patents issuing on an annual basis in the United States, it is a mammoth task to assure that all patents relating to a specific industry are accounted for and reviewed for blocking technology rights.

Therefore, it is desirable to provide for a more reliable automated system for tracking and analyzing patents and their relationships to specific industries.

### SUMMARY OF THE INVENTION

The present invention is directed to a method for identifying patents which are relevant to a field of endeavor by first establishing a set of criteria for defining the field of endeavor and storing the set of criteria in a searchable medium. Using this set of criteria, boundaries are defined within which external data would be considered relevant to the set of criteria. Then a patent database is accessed and compared to the boundaries which have been set in order to identify patents which are relevant to the set of criteria.

In the preferred of the invention, the patents in the patent database may be subdivided into subsections including at least the following subsections: claims, specification and prior art (primarily prior art patent citations) and optionally including the step of weighting the patents identified as relevant to the set of criteria dependent upon which subsection of each patent is relevant.

Typically, the set of criteria contains industry standards and/or specifications for a product and/or one or more existing patents.

In one embodiment of the invention, each relevant patent includes teachings that are blocking, complementary, independent or substitute technologies when compared to the set of criteria.

The subject invention is a method identifying patents necessary to practice in specific technical fields, and where desired, further categorizing the technological interrelationships between patents and a set of criteria using network analytics and/or lexical similarity. The lexical similarity takes into account the text of patents and more specifically, the issued claims and the correlation of this text with the technology to which the patent is directed, providing a foundational structure for said lexical similarity. By using this link similarity (structural similarity and cross-referencing of citations) and lexical similarity (textual, for example the patent specification) either alone or in combination, the invention provides a method whereby the patented technology can be compared to technology in a specific sphere to determine whether the technological interrelationship falls into any of the four following categories: Blocking, Complementary, Independent or Substitute (“BCIS”).

The methodology of the subject invention permits those parties competing in a defined technological field to determine the extent of protected technology within the field. Such information is useful for each component of the BCIS model. In addition, such information is useful for comparing and revising standards related to the technological field.

The methodology of the subject invention analyzes the first two categories identified above, specifically the essential patents and the interrelationship thereof with the patent claims, abstract and description. The third category identified above, the BCIS modeling method, is designed to classify the technology based on the whole body of information within the boundaries of the patent and provides a more accurate, more detailed analysis as a party or industry attempts to identify and categorize relevant technology as blocking, complementary, independent or substitute with respect to the technological reference point. As most industries move in an evolutionary rather than in a revolutionary mode, this technique is very useful in staying abreast of and even anticipating changes.

In the preferred embodiment, the method identifying patents which are relevant to a field of endeavor, first establishes a set of criteria for defining the field of endeavor, and storing these criteria in a searchable medium. The boundaries within which external data would be considered relevant to the set of criteria are then established. A patent database is accessed and the patents therein are compared with the set of criteria to identify patents which are relevant to the set of criteria. The patents in the database may be broken into subcategories or subsections including the at least the following subsections: claims, specification and cited patents and/or non-patent citations and including the step of weighting the patents identified as relevant to the set of criteria dependent upon which subsection of each patent is relevant. The set of criteria may, by way of examples, contain contains industry standards, product specifications, and/or one or more existing patents.

In the preferred embodiment the boundaries are defined by identifying whether each relevant patent includes teachings that are blocking, complementary, independent or substitute technologies when compared to the set of criteria.

Basically, by making this detailed comparative analysis, the whole body of technology is available for review, rather than relying on the methods of the past, where specific technology review was primarily limited to where an industry is, rather than where it may be headed due to both internal and external influences.

One very practical use of the method is to compare the body of patented technology with the standards established for an industry. Assuming the standards identify the acceptable state of technology for a specific sphere, then comparison of these standards to the BCIS patent model will provide a map of the technology landscape for the industry. Specifically, the methodology of the subject invention provides a tool identifying patents which are essential in the chosen sphere.

As an example, when patent A blocks patent B, the owner of patent B cannot practice his invention without obtaining rights to patent A. Conversely, the owner of patent A may not be able to practice the most current version of the technology without obtaining rights under patent B. So in this example patent A blocks the owner of patent B from participating in a specific technological sphere, while patent B blocks the owner of patent A from competing with the most desirable version of the technology.

Complementary technology is defined when at least two patents provide additional benefits when used in combination, but the technology can be used independently without interference by one patent with respect to the other. An example may be a catalyzing technology covered by patent A in combination with another technology covered in patent B, wherein the inclusion of patent B enhances the performance of the catalyst but is not necessary to its performance. The enhancer in patent B may have uses which are completely independent of the catalyst covered in patent A. In this example, patents A and B are complementary, but not blocking. Rights under both patents are not required to practice in the chosen technological sphere.

Independent patents are simply that. Specifically, the technology described in each patent is in an independent and distinct technological sphere. Typically, this is referred to as non-analogous art. While the patents may use the same terms and may include similar features, the technological sphere of one patent is non-analogous to the technological sphere of the other patent. An historic example of independent technologies with related patent categories is the comparison of juke box art to automatic machine tool changer art. Both technologies require a spindle, an arm to pick up the device (a record or a tool), a work station where the device is used, and a storage system for storing the device when not in use. However, the technological spheres in which the two systems operate are completely independent of one another. Specifically, patents covering juke boxes are non-analogous to patents covering machine tool changers, using the methodology of the subject invention, the independent nature of the technology covered in these patents would be readily apparent.

Substitute technology is defined as two technologies which, while not independent of one another, can be practiced simultaneously without infringing on or invading the space of one another. An example is a pen and a pencil. Both are writing instruments and both are used largely to perform the same tasks. However, in most cases the development of pen technology is completely independent of the development of pencil technology. The technologies can be substituted for one another, but a patent relating to one neither blocks nor complements the technology covered by a patent relating to the other. However, unlike the independent technologies, the art is analogous in that the technological sphere in which the two technologies operate is overlapping and somewhat coextensive. When forming a patent pool, however, the antitrust regime specifically prohibits the inclusion of substitute technologies in the pool. Therefore, identification of substitutes is essential for formation of a patent pool that will withstand antitrust scrutiny.

Using the methodology of the subject invention, a method is provided for identifying and analyzing a body of patents to define essential patents required to practice in a specific technical sphere. In the example utilized in the subject patent application, the technological sphere is defined by using industry standards. This would include a definition of the industry sphere or market as well as standards that are applied in that market. By comparing the technical industry sphere with a body of patents, each patent can be identified and analyzed to determine whether or not it is essential in order to practice within the chosen industry sphere or market. With all patents as a whole body of technology, it stands to reason that most patents will fall into an independent or non-essential category. The key to the method is that it readily identifies patents which are essential and must be considered before proceeding.

### BRIEF DESCRIPTION OF THE DRAWINGS

FIG. 1 is a flow chart of a system incorporating the methodology of the subject invention.

FIG. 2 is an illustration of the interrelationship of blocking patents.

FIG. 3 is an illustration of the interrelationship of complementary patents.

### DESCRIPTION OF THE EXEMPLARY EMBODIMENT

The present invention is directed to a method for identifying patents which are relevant to a field of endeavor by first establishing a set of criteria for defining the field of endeavor and storing the set of criteria in a searchable medium. Specifically, the subject invention is a method identifying patents necessary to practice in specific technical fields, and where desired, further categorizing the technological interrelationships between patents and technological components of specific industries using network analytics and/or lexical similarity. Lexical similarity takes into account the text of patents and more specifically, the issued claims and the correlation of this text with the technology to which the patent is directed, providing a foundational structure for said lexical similarity. By analyzing this data, essential patents to the chosen field may be identified.

Using this set of criteria, boundaries are defined within which external data would be considered relevant to the set of criteria. Then a patent database is accessed and compared to the boundaries which have been set in order to identify patents which are relevant to the set of criteria.

In the preferred embodiment of the invention, the patents in the patent database may be subdivided into subsections including at least the following subsections: claims, specification and prior art and including the step of weighting the patents identified as relevant to the set of criteria dependent upon which subsection of each patent is relevant.

Typically, the set of criteria contains industry standards and/or specifications for a product, and/or one or more existing patents.

In one embodiment of the invention, each relevant patent includes teachings that are blocking, complementary, independent or substitute technologies when compared to the set of criteria.

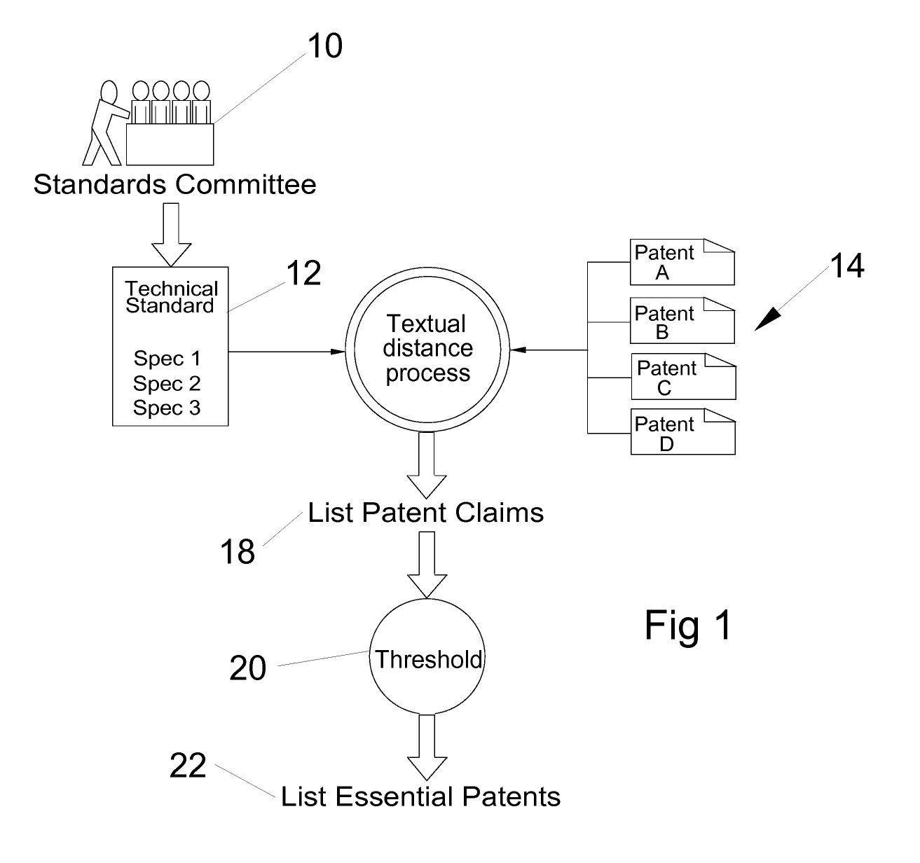

With specific reference to FIG. 1, typically the technological sphere of a specific industry will be defined by a standards committee or similarly functioning body 10. In the practice of the subject invention, the standard, generally in the form of specifications, are entered into a dynamic data base 12. The body of patents A, B, C, D and so on, is also entered into or available from a public source data base 14. The texts of the standards are then compared to the text of the patents using a lexical similarity process to identify patents which may fall within the technological sphere identified by the standards. Generally, this will be accomplished by comparing the two bodies of text at a server 16 which is in communication with the two data bases 12 and 14.

From this comparison the system will generate a list or group of claims and the associated patent, as indicated at 18 and compare the list with thresholds 20 for identifying patents as falling into one of the BCIS categories. For example, if the system is used to identify blocking patents, the critical technology criteria would be extracted from the standards in data base 12 and this would be essential information required to identify a list of pertinent patents and claims, or the search threshold 20. From this a list of essential patents can be generated, as indicated at 22.

Specifically, the method of the invention involves the following steps: identifying the technical criteria and developing from that criteria a text model; comparing the text model with a body of patents to develop similarities in language; identifying a threshold level of comparison to determine where the patents fit in the BCIS model when compared to the text model for the chosen technological sphere; and generating a list of essential patents which fall within the defined boundaries.

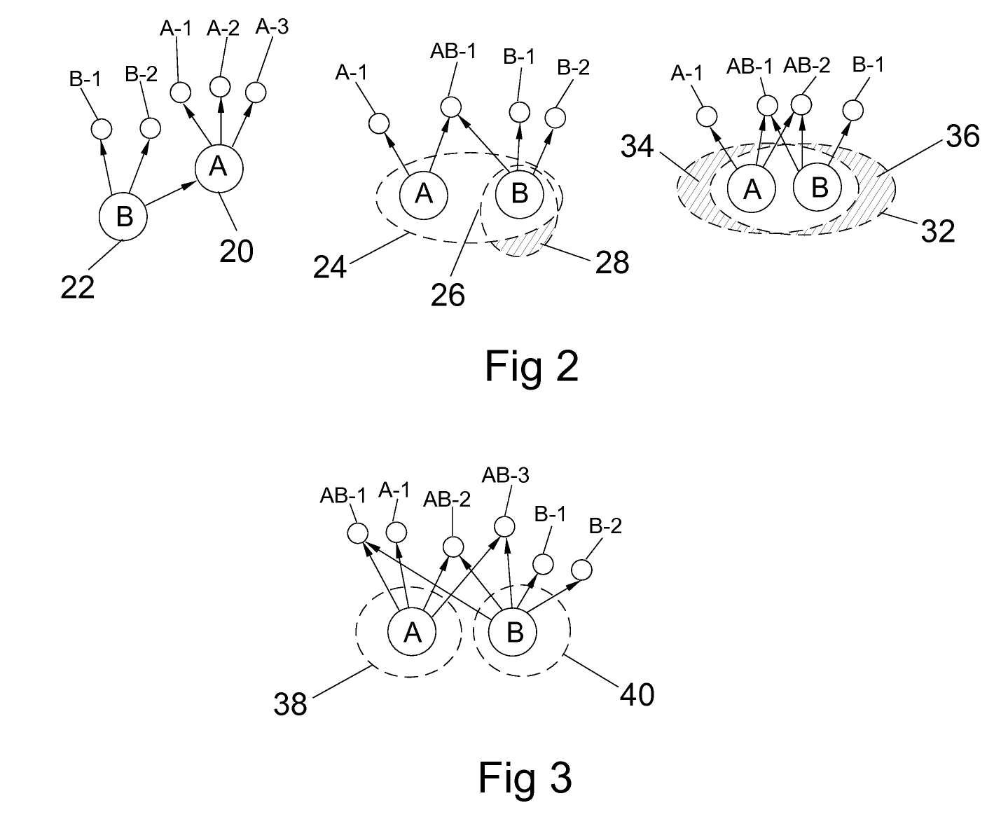

As previously stated, the patents will fall into one of the four BCIS categories: Blocking; Complementary; Independent; and Substitute. Where desired, the essential patents identified may be further analyzed to determine where they fall within the four categories. Illustrations of interrelationships between patents are shown in FIGS. 2-3.

As shown in FIG. 2, where an older patent A (20) is a blocking patent, the older patent A (20) will block the use of technology covered by the newer patent B (22), requiring the owner of Patents A and B in this model may fall into largely controlled technological spheres 24 and 28, as shown in FIG. 2. The cited prior-art references for Patents A and B are shown as A-1, A-2, and A-3, and B-1 and B-2, respectively. Where there are common cited references, these are identified as AB-1 and/or AB-2. The area within Space 24 covers the equivalency range of patent A. The area within space 26 covers the equivalency range of patent B. It will be noted in the example that Patents A and B largely overlap, with Patent B extending beyond the sphere of Patent A by the smaller area designated as area 28. Another example of the equivalency overlap is shown where the non-common ranges are listed as areas 32 and 34.

An example of complementary patents is shown in FIG. 3. As there indicated, each patent A and patent B are in independent, non-overlapping spheres 38 and 40, respectively.

The method of the subject invention provides a process for identifying and categorizing patents and their relevance to an industry, identifying the patents as blocking, complementary, independent or substitute as compared to a set of criteria. While certain features and embodiments of the invention are described in detail herein, it should be understood that the invention encompasses all of the modifications, enhancements and improvements within the scope of the appended claims.

I claim:

1. A method for identifying patents which are relevant to a field of endeavor, comprising the steps of:
a. Establishing a set of criteria for defining the field of endeavor;
b. Storing the set of criteria in a searchable medium;
c. Defining boundaries within which external data would be considered relevant to the set of criteria;
d. Accessing a patent database;
e. Comparing the patent database with the set of criteria to identify patents which are relevant to the set of criteria.

2. The method of claim 1, further including the step of listing the identified patents.

3. The method of claim 1, including the step of breaking the patents in the patent database into subsections including the at least the following subsections: claims, specification and cited patents and/or non-patent citations and optionally including the step of weighting the patents identified as relevant to the set of criteria dependent upon which subsection of each patent is relevant.

4. The method of claim 1, wherein the set of criteria contains industry standards.

5. The method of claim 1, wherein the set of criteria contains specifications for a product.

6. The method of claim 1, wherein the set of criteria contains one or more existing patents.

7. The method of claim 1, step of defining boundaries includes identifying whether each relevant patent includes teachings that are blocking, complementary, independent or substitute technologies when compared to the set of criteria.

8. A method for identifying patents which are relevant to a field of endeavor, comprising the steps of:
a. Establishing a set criteria for defining the field of endeavor;
b. Storing the set of criteria in a searchable medium;
c. Defining boundaries within which external data would be considered relevant to the set of criteria;
d. Accessing a patent database;
e. Comparing the patent database with the set of criteria to identify patents which are relevant to the set of criteria;
f. determining whether each relevant patent includes teachings that are blocking, complementary, independent or substitute technologies when compared to the set of criteria.

9. A method for identifying patents which are relevant to a field of endeavor, comprising the steps of:
a. Establishing a set criteria for defining the field of endeavor;
b. Storing the set of criteria in a searchable medium;
c. Defining boundaries within which external data would be considered relevant to the set of criteria;
d. Accessing a patent database;
e. Comparing the patent database with the set of criteria to identify patents which are relevant to the set of criteria
f. Subdividing the identified patents based on the language in the claims, specification and cited patents and/or non-patent citations.

10. The method of claim 9, further including the step of weighting the patents identified as relevant to the set of criteria dependent upon which subsection of each patent is relevant.

11. The method of claim 9, including the step of defining boundaries includes identifying whether each relevant patent includes teachings that are blocking, complementary, independent or substitute technologies when compared to the set of criteria.
